(19) United States
(12) Patent Application Publication
(10) Pub. No.: US 2026/0001050 A1
(43) Pub. Date: Jan. 1, 2026

(54) APPARATUS AND METHOD FOR AGITATING A FLUID

(71) Applicant: GLOBAL LIFE SCIENCES SOLUTIONS USA LLC, Marlborough, MA (US)

(72) Inventors: Kandakumar MURUGESAN, Bengaluru (IN); Bineesh KANDOTH, Bengaluru (IN); Nagaraj RAO, Bengaluru (IN)

(73) Assignee: GLOBAL LIFE SCIENCES SOLUTIONS USA LLC, Marlborough, MA (US)

(21) Appl. No.: 18/880,641

(22) PCT Filed: Jul. 17, 2023
(86) PCT No.: PCT/EP2023/069816

§ 371 Date: Jan. 2, 2025

(30) Foreign Application Priority Data
Jul. 26, 2022 (IN) 202211042728

(51) Int. Cl. B01F 33/453; B01F 31/40; B01F 35/513

(52) U.S. Cl. CPC B01F 33/4534; B01F 31/40; B01F 35/513

(57) ABSTRACT

A vessel includes an interior volume containing a liquid, a spiral shaft located within the interior volume, and a rotatable impeller. The impeller has an aperture that receives the spiral shaft and allows the impeller to travel bidirectionally along the spiral shaft. When the impeller travels along the spiral shaft, the impeller rotates axially about the spiral shaft to agitate a liquid in the interior volume.

### CROSS-REFERENCE TO RELATED APPLICATIONS

This application is a national stage of International Application No. PCT/EP2023/069816 filed on Jul. 17, 2023, which claims the benefit of India application Ser. No. 202211042728, filed on Jul. 26, 2022, all of which are hereby incorporated by reference herein in their entireties.

### BACKGROUND

### Technical Field

Embodiments of the invention relate generally to bioprocessing apparatus, systems, and methods, and more particularly, to impellers used to agitate a fluid in a mixer or bioreactor bag.

### Discussion of Art

Mixers and bioreactors are often employed to carry out biochemical and/or biological processes and/or manipulate liquids and other products of such processes. Such mixers often include flexible or collapsible single-use disposable bags that are supported by an outer rigid structure such as a stainless-steel shell or housing. The bags are made of thin flexible sheets of plastic film and are positioned within the rigid housing and filled with the desired fluid for processing. The fluid within the bags requires mixing or agitation to prevent settling of particulates at the bottom of the bag.

Known mixing devices typically include a rotatable agitator or impeller that is fixedly mounted at the bottom of a disposable bag that is retained within a rigid tank or support Structure. Such impellers typically have a base portion that contains permanent magnets that are magnetically coupled to and driven by permanent magnets of a motor. In use, the motor magnets are rotated which rotate the base portion of the impeller about a shaft resulting in agitation of a fluid within the bag.

In known systems, however, the fixed impeller must be replaced with the single-use disposable bag. As will be appreciated, the magnets in the base portion of the impeller are also located within the bag and are therefore single-use, creating a high cost of consumables.

Moreover, the fixed location of the impeller within the bag may result in inefficient mixing. In particular, the impeller agitates only a small volume of the total liquid which contributes to settling of particulates from the liquid, typically to a location below the impeller. Modifying the impeller to act on more liquid, e.g., by increasing its size, requires larger magnets which are prohibitively expensive.

In view of the above, there is a need for an apparatus and system for agitating a fluid in a bioreactor bag that provides for efficient mixing, the prevention of particulate settlement, and a lower cost of manufacture.

### BRIEF DESCRIPTION

Certain embodiments commensurate in scope with the originally claimed subject matter are summarized below. These embodiments are not intended to limit the scope of the claimed subject matter, but rather these embodiments are intended only to provide a brief summary of the possible embodiments. Indeed, the disclosure may encompass a variety of forms that may be similar to or different from the embodiments set forth below

In an embodiment, a vessel includes an interior volume containing a liquid, a spiral shaft located within the interior volume, and a rotatable impeller. The impeller has an aperture that receives the spiral shaft and allows the impeller to travel bidirectionally along the spiral shaft. When the impeller travels along the spiral shaft, the impeller rotates axially about the spiral shaft to agitate the liquid in the interior volume.

In another embodiment of the invention, a bioreactor system includes a vessel having an interior volume containing a liquid, a spiral shaft located within the interior volume, a rotatable impeller, and a drive assembly that controls bidirectional travel of the impeller along the spiral shaft. The impeller has an aperture that receives the spiral shaft and allows the impeller to travel bidirectionally along the spiral shaft. When the impeller travels along the spiral shaft, the impeller rotates axially about the spiral shaft to agitate the liquid in the interior volume of the vessel.

In yet another embodiment, a method of agitating fluid in a vessel includes moving a rotatable impeller along a spiral shaft in a first direction. The spiral shaft is located within an interior volume of the vessel. When the impeller is moved along the spiral shaft in the first direction the impeller rotates axially about the spiral shaft to agitate a liquid in the interior volume.

### DRAWINGS

The present invention will be better understood from reading the following description of non-limiting embodiments, with reference to the attached drawings, wherein below:

FIG. 1 is an enlarged cross-sectional view of a mixer showing a known drive assembly and fixed impeller.

FIG. 2 is a front cross-sectional view of a mixer including a rotatable impeller, according to an embodiment of the present invention.

FIG. 3 is a perspective view of a portion of a spiral shaft and rotatable impeller of FIG. 2, according to an embodiment of the present invention.

FIG. 4 is a bottom view of the spiral shaft and the rotatable impeller of FIG. 3, according to an embodiment of the present invention.

FIG. 5 is a sectioned view of a mixer including a spiral shaft and rotatable impeller, depicting an electromagnet and magnetic impeller housing in a repulsion state, according to an embodiment of the present invention.

FIG. 6 is sectioned view of the mixer of FIG. 5, depicting an electromagnet and magnetic impeller housing in an attraction state, according to an embodiment of the present invention.

FIG. 7 is a perspective view of a mixer including another embodiment of a rotatable impeller that utilizes a linear actuator for axial movement, according to an embodiment of the present invention.

FIGS. 8A-8C are various views of the rotatable impeller and housing of FIG. 7 for use with a linear actuator in accordance with an embodiment of the invention.

### DETAILED DESCRIPTION

Reference will be made below in detail to exemplary embodiments of the invention, examples of which are illustrated in the accompanying drawings. Wherever possible, the same reference characters used throughout the drawings refer to the same or like parts.

As used herein, the term “flexible” or “collapsible” refers to a structure or material that is pliable, or capable of being bent without breaking, and may also refer to a material that is compressible or expandable. An example of a flexible structure is a bag formed of polyethylene film. The terms “rigid” and “semi-rigid” are used herein interchangeably to describe structures that are “non-collapsible,” that is to say structures that do not fold, collapse, or otherwise deform under normal forces to substantially reduce their elongate dimension. Depending on the context, “semi-rigid” can also denote a structure that is more flexible than a “rigid” element, e.g., a bendable tube or conduit, but still one that does not collapse longitudinally under normal conditions and forces.

A “vessel,” as the term is used herein, means a flexible bag, a flexible container, a semi-rigid container, or a rigid container, as the case may be. The term “vessel” as used herein is intended to encompass, but is not limited to, mixer or bioreactor vessels having a wall or a portion of a wall that is flexible or semi-rigid, single-use flexible bags, as well as other containers or conduits commonly used in biological or biochemical processing, including, for example, cell culture/purification systems, fermentation systems, media/buffer preparation systems, and filtration/purification systems.

As used herein, the term “bag” means a flexible or semi-rigid container or vessel used, for example, as a mixer or bioreactor for the contents within. While embodiments are described in connection with single-use, stirred tank mixer systems, they are not limited to the same and may be used with a variety of vessels and associated equipment used in biological or biochemical processing. Additionally, embodiments may be suitable for mixing or agitating fluids in other non-biological/biochemical contexts.

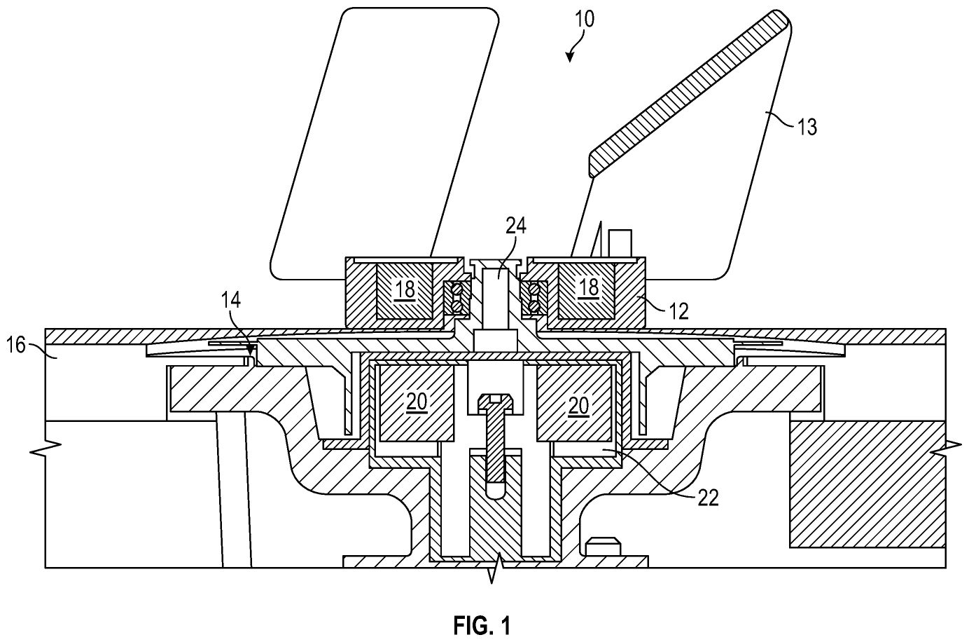

Referring now to FIG. 1, a known rotatable agitator or impeller 10 is depicted. The impeller 10 has a base portion 12 that is mounted in shaft 24. A bottom surface 14 of a disposable bag is retained within a rigid tank or support structure 16, which may be formed, for example, from stainless steel, polymers, composites, glass, or other metals and may be cylindrical in shape, although other shapes may be utilized, as long as it is capable of supporting a single-use flexible mixer or bioprocessing/bioreactor bag.

The base portion 12 includes one or more blades 13 and also contains permanent magnets 18 that, in use, are magnetically coupled to and driven by permanent magnets 20 of a motor 22. In use, the motor magnets 20 are rotated, which rotate the base portion 12 of the impeller 10 about a shaft 24 resulting in agitation of a fluid within the bag.

As mentioned, the fixed impeller 10 containing multiple magnets 18 that must be replaced with the single-use disposable bag (i.e., after a number of uses the single-use disposable bag must be replaced, which requires replacement of the fixed impeller 10 also). Moreover, the fixed location of the impeller 10 within the bag may result in inefficient mixing and the agitation of only a small volume of the total liquid which contributes to settling of particulates from the liquid, typically to a location below the impeller 10. Modifying the impeller 10 to act on more liquid, e.g., by increasing its size, requires larger magnets which are prohibitively expensive.

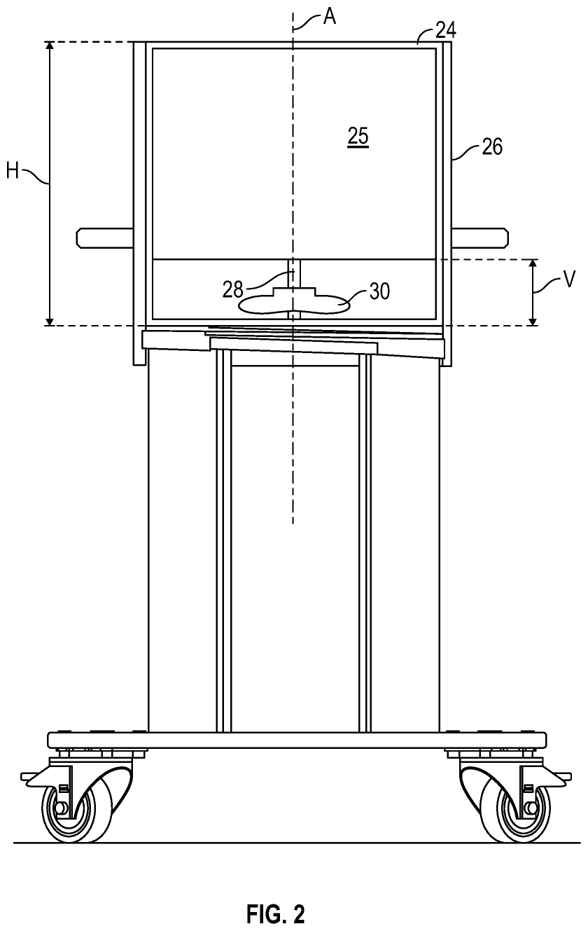

Referring now to FIG. 2, a vessel 24 according to an embodiment of the present invention includes an interior volume 25 configured to receive and contain a fluid for processing/mixing. The vessel 24 has an overall height H and a minimum working volume level or height V. The interior volume 25 of the vessel 24 further includes a spiral shaft 28 and a rotatable impeller 30. In embodiments, the spiral shaft 28 has a height that is approximately the same as the minimum working volume height V or more than the minimum working volume height V. The impeller travels an axial height that is controlled by the drive assembly 56 according to the height of the liquid. This height ensures that, in use, the impeller 30 will remain immersed in fluid in the interior volume 25. As will be appreciated, in certain embodiments, the height of the spiral shaft 28 may depart from (e.g., be lower than) the minimum working volume height V without departing from the invention.

As described in greater detail below, when the impeller 30 travels along the spiral shaft 28, the impeller 30 rotates axially about the spiral shaft 28 to mix or otherwise agitate a liquid in the interior volume 25. The impeller 30 rotates as it moves linearly along the spiral shaft 28, which features a spiral profile that turns linear motion along the spiral shaft 28 into rotating motion of the impeller 30.

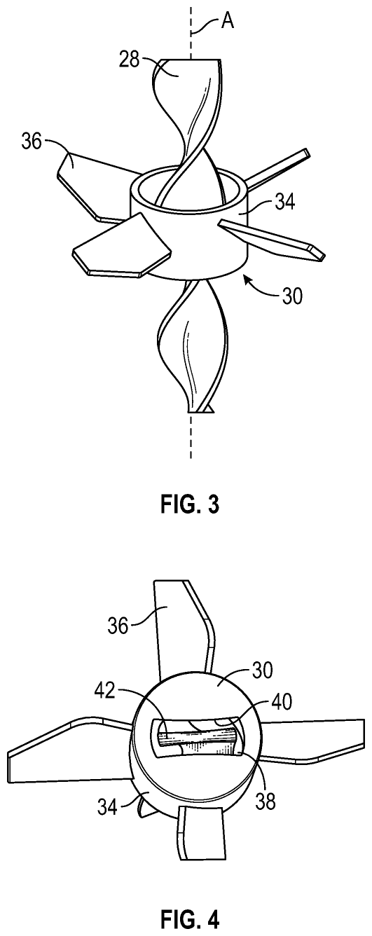

More specifically, in an embodiment shown in FIGS. 3 and 4, the impeller 30 includes a generally circular base portion 34 that includes one or more blades 36. In the depicted embodiment there are four blades, but, as will be appreciated, other numbers, shapes, and sizes of blades may be utilized without departing from the invention.

As shown in FIG. 4, the base potion 34 includes an aperture 38 that receives the spiral shaft 28 and allows the impeller 30 to travel bidirectionally along the spiral shaft 28. The aperture 38 is defined by an interior aperture edge 40 that defines the shape of the aperture 38 and is substantially complementary in shape to the cross-section of the spiral shaft 28.

Referring to FIG. 4, in an embodiment, the spiral shaft 28 has a substantially rectangular cross-section 42, and similarly the aperture 38 has a complementary rectangular shape. The shaft 28 is twisted or rotated so that the shaft 28 has an overall spiral or twisted profile. In particular, the cross-section 42 of the spiral shaft 28 rotates about the longitudinal axis A, moving from one end of the spiral shaft 28 to the opposite end along the longitudinal axis A. Although the spiral shaft 28 is shown with a substantially rectangular cross section, other shapes are possible without departing from the invention.

The spiral profile of the shaft 28 and the complementary shape of the aperture 38 cause the impeller 30 to rotate about the longitudinal axis A as it travels along the spiral shaft 28. In particular, the impeller aperture 38 engages the cross-sectional profile of the spiral shaft 28, resulting in axial rotation of the impeller 30 when the impeller 30 is moved linearly along the shaft 28. As will be appreciated, a change in direction of travel of the impeller 30 on the shaft 28 reverses the direction of rotation of the impeller 30.

The spiral shaft 28 and impeller 30 may be manufactured from a variety of materials including, but not limited to plastics and metals. In an embodiment, the shaft 28 and/or the impeller 30 may include a coating to reduce the emission of particulates caused by contact of the aperture 38 with the shaft 28 during use. In an embodiment, ceramic coatings such as a titanium-based coating may be utilized. In other embodiments, polymeric coatings or composites may be employed. The coatings may be located on the shaft 28 and/or the impeller 30 and may be applied via known techniques including, but not limited to, additive manufacturing.

As will be appreciated, the number of turns or twists per unit of linear measurement of the shaft 28, e.g., centimeter or inches, may vary without departing from the invention.

The mixing efficiency of the rotating impeller 30 disclosed herein is significantly better than fixed impellers because the impeller 30 moves bidirectionally up and down along the spiral shaft 28. This linear movement of the impeller 30 removes settling of particulates that may occur in the bottom of the vessel 24 (typically underneath the fixed impeller in known systems) by creating an up-and-down pumping motion with the rotating impeller 30. This movement of the impeller 30 also allows a single impeller 30 to perform the work of multi-stage fixed location impellers (not depicted) in which multiple impellers are stacked axially about a shaft at the bottom of the interior of a vessel.

While embodiments present an alternative to multiple stacked fixed impellers, in aspects multiple rotatable impellers 30 may travel along spiral shaft 28 without departing from the scope of the invention.

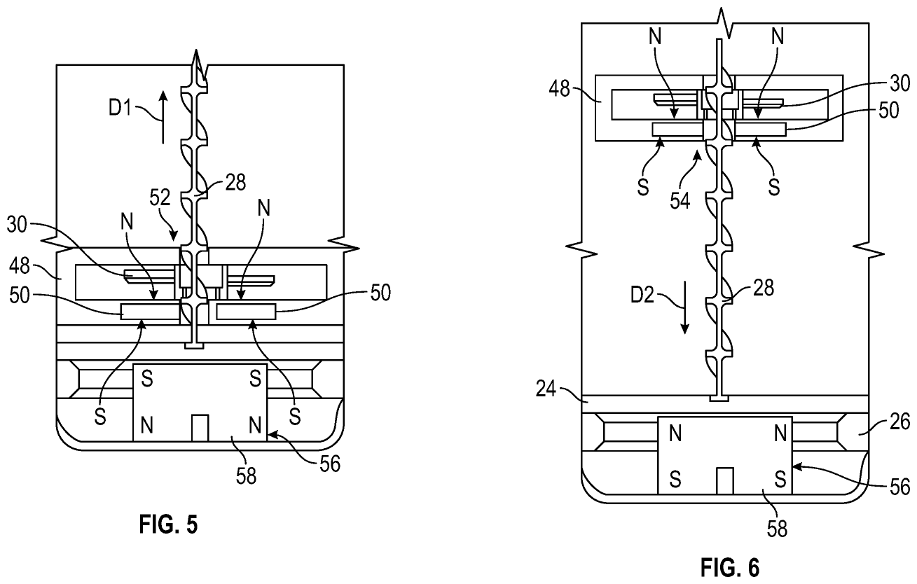

In embodiments, the impeller 30 includes a housing 48, 148 (See, FIGS. 5, 6, and 8A-8C). Housings 48, 148 facilitate bidirectional travel of the impeller 30 on the shaft 28, as well as to protect the bottom surface 14 of the bag from being scratched or otherwise punctured by the blades 36 during shipping or in use. In the embodiment shown in FIGS. 5 and 6, the housing 48, 148 is a substantially rectangular, box-like structure with one or more open sides/faces. The housing 48, 148 has upper and lower surfaces (relative to the top and bottom of the vessel/bag) that include holes that accommodate the passage of the shaft 28. In particular, the housing 48 has an upper housing aperture 52 and a lower housing aperture 54. As shown, the impeller 30 fits within housing 48.

Turning now to FIGS. 5 and 6, the assembled housing 48 and impeller 30 may be raised and/or lowered about the shaft 28 via the use of magnets. In embodiments, the impeller 30 is operatively connected to at least one impeller magnet 50 that is located within the housing 48. The magnet(s) 50 may be permanent or temporary and may be manufactured from steel, Iron, Cobalt, Nickel, and alloys thereof. The magnet(s) 50 may be in a variety of shapes, sizes, and locations. In an embodiment, the magnets are located in proximity to, e.g., surrounding, the lower housing aperture 54 through which the shaft 28 passes.

In an embodiment, the bidirectional travel of the impeller 30 and housing 48 along the spiral shaft 28 is accomplished via a drive assembly 56. The drive assembly 56 may include an electromagnet 58 that can selectively change polarity to move the impeller 30 bidirectionally along the spiral shaft 28. In alternative embodiments, the magnet(s) 50 can be integrated directly into the impeller 30 (e.g., into the base portion 34 and/or the blades 36).

More specifically, in FIG. 5, the drive assembly 56 changes the polarity of the electromagnet 58 to match the polarity of the impeller magnet(s) 50 to create an S-S polar repulsion state, magnetically propelling the impeller 30 away from the drive assembly 56 in direction D1. This causes the housing 48 to rise upward along the shaft 28, thereby urging the impeller 30 upward resulting in rotation of the impeller 30 as it travels linearly up the spiral shaft 28.

In FIG. 6, the drive assembly 56 changes the polarity of the electromagnet 58 to be opposite the polarity of the impeller magnets 50 to create a N-S attraction state, magnetically drawing the impeller 30 towards the drive assembly 56. As will be appreciated, this causes the impeller 30 and housing 48 to lower along the shaft 28 in direction D2, resulting in counter rotation of the impeller 30.

In embodiments, electromagnets having sufficient strength to raise and/or lower the impeller 30 may be utilized without departing from the invention. In particular, the strength of the current may vary depending upon, for example, the agitation torque/revolutions per minute (RPM) requirements for the vessel.

In embodiments, the polarity of the electromagnet 58 can be reversed at predetermined automated intervals. In this way, the shaft 28 does not require a mechanical stop (although the inclusion of a mechanical stop at the top of the shaft 28 is within the scope of the invention), rather as the housing 48 and impeller 30 approach the top of the shaft 28, the polarity can be automatically reversed to prevent the housing and impeller from departing the shaft 28. In other embodiments, it may be possible to activate the electromagnet 58 to agitate/mix the fluid in response to a detected condition within the fluid or vessel. In yet other embodiments, the electromagnet 58 may simply shut off when the impeller 30 and housing 48 near the top of the shaft 28 so that the impeller 30 and housing 48 return to their starting position via gravity.

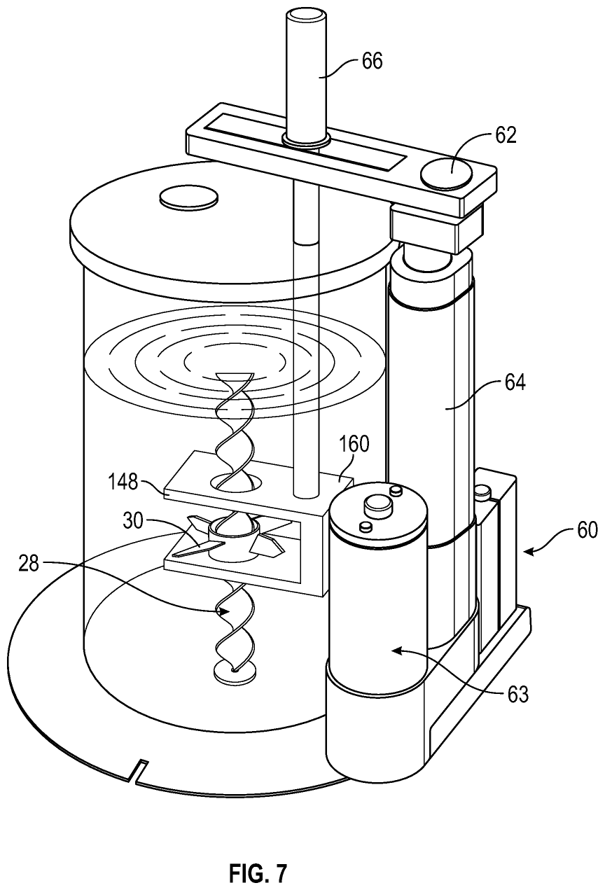

Referring now to FIG. 7, in an alternative embodiment, the impeller 30 may be raised or lower via an electric linear actuator 60. The linear actuator 60 includes a motor 63 that extends and retracts a piston-like pole portion 64, which includes an arm 62 and a housing connector 66. The housing connector 66 is substantially parallel to the pole portion 64 and raises or lowers with the pole portion 64.

Referring to FIG. 7, the housing connector 66 of the linear actuator 60 is connected to the housing 148. The connector 66 may attach to the housing 148 at surface 160, though other attachment areas are possible. In embodiments, the connector 66 may be unitary with the housing 148. In other embodiments, it may be detachable from the housing 148.

In this embodiment, the housing 148 is a substantially U-shaped bracket having first and second apertures 150, 152 sized and shaped to allow passage of the shaft 28. In use, the impeller 30 fits within the housing 148 and when the connector 60 is raised or lowered, the housing 148 contacts and moves the impeller 30 up or down the spiral shaft 28, resulting in rotation of the impeller 30.

In embodiments, the speed of the linear actuator may be selectively variable. As will be appreciated, in these embodiments the speed may be increased or decreased to change the RPM of the impeller.

The housing 148 omits magnets because it is directly moved by the linear actuator 60. This significantly decreases the cost of the impeller 30. In embodiments, the linear actuator 60 is located outside the vessel and may extend into the vessel interior volume 25 to engage the impeller 30 and housing 148 through a sealed port.

A method of agitating fluid in a vessel 24 is also disclosed herein. The method includes moving a rotatable impeller 30 along a spiral shaft 28 in a first direction D1. The spiral shaft 28 is located within an interior volume 25 of the vessel 24. When the impeller 30 is moved along the spiral shaft 28 in the first direction the impeller 30 rotates axially about the spiral shaft 28 to agitate a liquid in the interior volume 25.

In some embodiments, the method also includes moving the rotatable impeller 30 along the spiral shaft 28 in a second direction D2 that is opposite the first direction. Moving the impeller 30 along the spiral shaft 28 in the first direction rotates the impeller 30 in a first direction and moving the impeller 30 in the second direction rotates the impeller 30 in a second direction that is opposite to the first direction.

Referring to FIGS. 5-6, in embodiments in which the rotatable impeller 30 is moved along the spiral shaft 28 via a drive assembly 56, which includes an electromagnet 58, the method also includes changing a polarity of the electromagnet 58 to move the rotatable impeller 30 along the spiral shaft 28 in a second direction that is opposite the first direction. In some embodiments, the method includes changing a strength of the electromagnet 58 to change an RPM of the rotatable impeller 30.

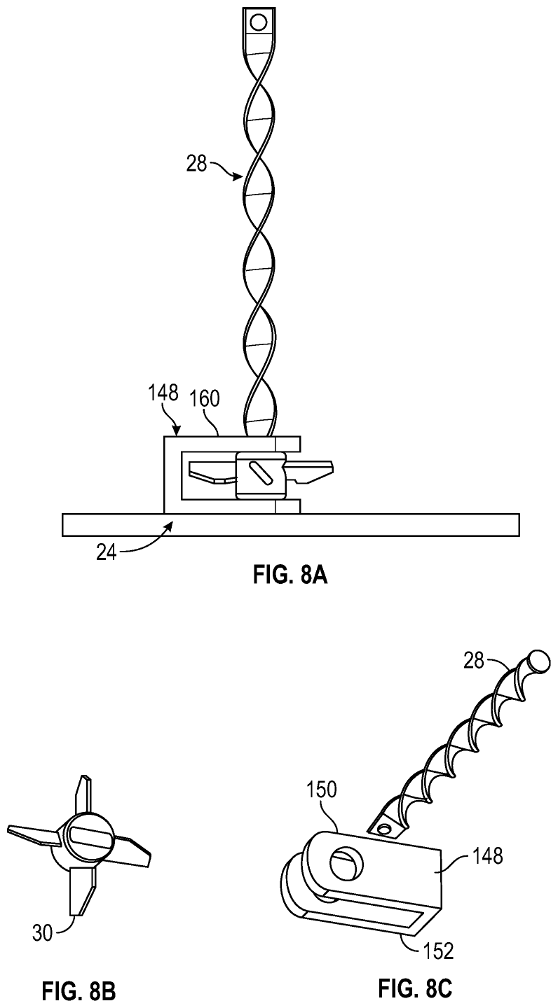

Referring to FIGS. 7 and 8A-8C, in embodiments in which the rotatable impeller 30 is moved along the spiral shaft 28 via a linear actuator 60, the method also includes changing a speed of the linear actuator 60 to change an RPM of the rotatable impeller 30.

As used herein, an element or step recited in the singular and proceeded with the word “a” or “an” should be understood as not excluding plural of said elements or steps, unless such exclusion is explicitly stated. Furthermore, references to “one embodiment” of the present invention are not intended to be interpreted as excluding the existence of additional embodiments that also incorporate the recited features. Moreover, unless explicitly stated to the contrary, embodiments “comprising,” “including,” or “having” an element or a plurality of elements having a particular property may include additional such elements not having that property.

While the dimensions and types of materials described herein are intended to define the parameters of the invention, they are by no means limiting and are exemplary embodiments. Many other embodiments will be apparent to those of skill in the art upon reviewing the above description. The scope of the invention should, therefore, be determined with reference to the appended claims, along with the full scope of equivalents to which such claims are entitled. In the appended claims, the terms “including” and “in which” are used as the plain-English equivalents of the respective terms “comprising” and “wherein.” Moreover, in the following claims, terms such as “first,” “second,” “upper,” “lower,” “bottom,” “top,” etc. are used merely as labels, and are not intended to impose numerical or positional requirements on their objects. Further, the limitations of the following claims are not written in means-plus-function format and are not intended to be interpreted as such, unless and until such claim limitations expressly use the phrase “means for” followed by a statement of function void of further structure.

This written description uses examples to disclose several embodiments of the invention, including the best mode, and also to enable one of ordinary skill in the art to practice the embodiments of invention, including making and using any devices or systems and performing any incorporated methods. The patentable scope of the invention is defined by the claims, and may include other examples that occur to one of ordinary skill in the art. Such other examples are intended to be within the scope of the claims if they have structural elements that do not differ from the literal language of the claims, or if they include equivalent structural elements with insubstantial differences from the literal languages of the claims.

What is claimed is:

1-15. (canceled)

16. A vessel comprising:
a. an interior volume configured to contain a liquid;
b. a spiral shaft located within the interior volume;
c. a rotatable impeller;
d. the rotatable impeller having an aperture configured to receive the spiral shaft and allow the rotatable impeller to travel bidirectionally along the spiral shaft; and
e. wherein when the rotatable impeller travels along the spiral shaft, the rotatable impeller rotates axially about the spiral shaft to agitate a liquid in the interior volume.

17. The vessel of claim 1, further comprising:
a. a housing within which the rotatable impeller is located, the housing including a housing aperture configured to receive the spiral shaft.

18. The vessel of claim 1, wherein the rotatable impeller is operatively connected to at least one impeller magnet that allows for control of the bidirectional travel of the rotatable impeller along the spiral shaft via a drive assembly.

19. The vessel of claim 3, wherein the drive assembly includes an electromagnet that can selectively change polarity to move the rotatable impeller bidirectionally along the spiral shaft.

20. The vessel of claim 1, wherein the rotatable impeller is configured for operative attachment to a linear actuator that may be used to control the bidirectional travel of the rotatable impeller along the spiral shaft.

21. The vessel of claim 1, wherein the impeller aperture is a slot configured to engage a cross-sectional profile of the spiral shaft resulting in axial rotation of the rotatable impeller when the rotatable impeller is moved linearly along the spiral shaft.

22. The vessel of claim 1, wherein the spiral shaft has a length that is substantially equal to or less than a minimum working volume height of the vessel.

23. The vessel of claim 1, wherein the vessel is a collapsible bag.

24. The vessel of claim 1, wherein the vessel is a bioreactor bag.

25. A bioreactor system comprising:
a. a vessel having an interior volume configured to contain a liquid;
b. a spiral shaft located within the interior volume;
c. a rotatable impeller;
d. the rotatable impeller having an aperture configured to receive the spiral shaft and allow the rotatable impeller to travel bidirectionally along the spiral shaft;
e. a drive assembly configured to control bidirectional travel of the rotatable impeller along the spiral shaft; and
f. wherein when the rotatable impeller travels along the spiral shaft, the rotatable impeller rotates axially about the spiral shaft to agitate a liquid in the interior volume of the vessel.

26. The bioreactor system of claim 10, wherein the rotatable impeller is operatively connected to at least one impeller magnet that allows for control of the bidirectional travel of the rotatable impeller along the spiral shaft via the drive assembly.

27. The bioreactor system of claim 11, wherein the drive assembly includes an electromagnet that can selectively change polarity to move the rotatable impeller bidirectionally along the spiral shaft.

28. The bioreactor system of claim 10, wherein the drive assembly includes a linear actuator that may be used to control the bidirectional travel of the housing and rotatable impeller along the spiral shaft.

29. The bioreactor system of claim 10, wherein the impeller aperture is a slot configured to engage a cross-sectional profile of the spiral shaft resulting in axial rotation of the rotatable impeller when the rotatable impeller is moved linearly along the spiral shaft.

30. The bioreactor system of claim 10, wherein the spiral shaft has a length that is substantially equal to or less than a minimum working volume height of the vessel
